(19) United States
(12) Patent Application Publication
(10) Pub. No.: US 2008/0010468 A1
(43) Pub. Date: Jan. 10, 2008

(54) Method and technique for enforcing transience and propagation constraints on data transmitted by one entity to another entity by means of data division and retention

(76) Inventor: R. P. Ruiz, Washington, DC (US)

Correspondence Address: R.P. Ruiz, APT 722, 1801 CLYDESDALE PL NW, WASHINGTON, DC, 20009, US

(21) Appl. No.: 11/810,461

(22) Filed: Jun. 5, 2007

Related U.S. Application Data
(60) Provisional application No. 60/811,384, filed on Jun. 6, 2006.

(51) Int. Cl. H04L 9/28

(52) U.S. Cl. 713/189

(57) ABSTRACT

A method for constraining and disabling the redistribution of computer data, specifically such data that are not intended to be disseminated further than their intended recipient (103) (209); for constraining and enforcing the transience of electronic data beyond a given expiration date or number of times accessed (108) (205); for constraining and enforcing a data issuer's permissions to forward (202), print (212) or archive (212) the issued electronic data.

### CROSS-REFERENCE TO RELATED APPLICATIONS

Provisional Patent Application 60/811384, filed on Jun. 6, 2006.

### FEDERALLY SPONSORED RESEARCH

Not Applicable

### SEQUENCE LISTING OR PROGRAM

Not Applicable

### BACKGROUND OF THE INVENTION

This invention relates to constraining and disabling the redistribution of computer data, specifically such data that are not intended to be disseminated further than their intended recipient; to constraining and enforcing the transience of electronic data beyond a given expiration date or the number of times accessed; to constraining and enforcing a data issuer's permissions to forward, print or archive the constrained electronic data.

### BACKGROUND OF THE INVENTION

Many digital rights management systems have attempted to disallow the propagation of data transmitted from its intended recipient to other unintended recipients by embedding symmetric encryption keys within the data to be constrained. The main problem with such strategies is that those wishing to redistribute the data need only analyze its contents in order to find the decryption key and then use it. One example of this type of strategy is CSS, the Content Scrambling System used on DVDs; its source code was released on the Internet in 1999 allowing computer users to circumvent its anti-propagation or access-restriction logic.

Other patents relevant to this application are: 1) “Structural of digital rights management (DRM) system” (U.S. Pat. No. 7,024,393) and 2) “Rendering digital content in an encrypted rights-protected form” (U.S. Pat. No. 6,775,655), both of which are examples of client based license storage, in which the information pertinent to deciding whether the rendering client should display the information is stored on the client computer. The problems in these two designs are 1) the inherent risk of exposure to manipulation due to the chosen storage location of both content and access licenses on the requesting client's computer, and 2) the logistical component of maintaining and updating the inner workings of these client license stores.

In summary, the risk of subverting the above mentioned prior art is largely due to the the design choices in which either the decryption key or the digital license conferring decryption and rendering rights are distributed: that is, they are stored on the requesting client's computer or DVD ROM. This exposes the propagation restricted content to significant risk of unauthorized distribution and/or access.

### BACKGROUND OF INVENTION—OBJECTS AND ADVANTAGES

The Data Transience and Propagation Constraint Enforcer is superior to the previously cited examples because it enforces issuer specified constraints without the risk of including subvertable embedded decryption keys that can be reused to propagate the data beyond its intended recipients. It also mitigates the risk of manipulation of client stored access licenses by centralizing constrained data storage logic on a protected centralized server computer. Both design advantages are further enhanced by by employing the following strategies:
(a) Use of Public key encryption: the data to be transmitted is encrypted to its recipients' public key, ensuring that only entities with access to the corresponding private keys may decrypt the content.
(b) Use of data division and retention: only a predetermined percentage of a given data set is actually transmitted to its recipient, the remaining percentage is retained on a separate computer repository called a server. This retained complementary data is polled every n seconds to verify that it hasn't yet expired. If it has, then the retaining server computer deletes it. While this strategy allows the recipients to potentially keep their predetermined percentage of the data set in perpetuity, the ability to access it is dependent upon the retained data existing on the separate designated server computer: if the complementary data has expired and is thus non-existent, then the whole of the original encrypted data set cannot be reconstructed, much less decrypted, decompressed and accessed.
(c) Use of a “smart” data consumer client: once a transmission is received, merged and decrypted in preparation for consumption, the data consumer verifies that all programmatic facilities to copy, print and/or save the data are enable or disabled according to the constraint imposed by the issuer.
(d) Creation of digital signatures before transmission: all data are signed by their sender before division and transmission. Any messages that have been modified in transit are detected via the digital signature confirmation process. All data with with unverified signatures are considered to be forgeries by the data consumer module, and are discarded before consumption or rendering takes place.

### SUMMARY

Using the present invention described, it is now possible to enforce transience and propagation constraints on data transmitted from one entity to another. Someone using this system may send data, say an email message, of an transient (or ephemeral) nature to a recipient who may then be limited to viewing it a maximum of n times or until a sender specified expiration date has elapsed. Further, at the sender's request, the recipient may also have their capacity to print, copy, and save the constrained data disabled. An additional property of this system is that while the recipient may forward the constrained content to others, it will only be legible to its explicitly intended recipients.

### DRAWINGS—FIGURES

FIG. 1 shows the Data Division and Retention Process

FIG. 2 shows the Data Request and Merge Process

### DRAWINGS—REFERENCE NUMERALS

| | |
|---|---|
| 100 Data input | 101 Digital signature |
| 102 Data compression | 103 Data encryption to recipient |
| 104 Data division | 105 Data wrapping |
| 106 Data queuing | 107 Data unwrapping |
| 108 Period expiration check | 109 Wait state |
| 110 Data deletion | 111 Process termination |
| 112 Data transmission preparation | 113 Data transmission |
| 114 Constraint meta recording | 115 Standard network connectivity |
| 200 Authentication request | 201 Begin authentication |
| 202 Authentication decision block | 203 Authentication process |
| | termination |
| 204 Retained data request | 205 Data availability decision |
| 206 Data constraint update | 207 Retained data access |
| 208 Data merge | 209 Data decryption |
| 210 Data decompression | 211 Signature derivation |
| 212 Data consumption according to | 213 Process termination |
| constraint meta data | |
| 214 Signature verification | 215 Standard network connectivity |
| decision block | |

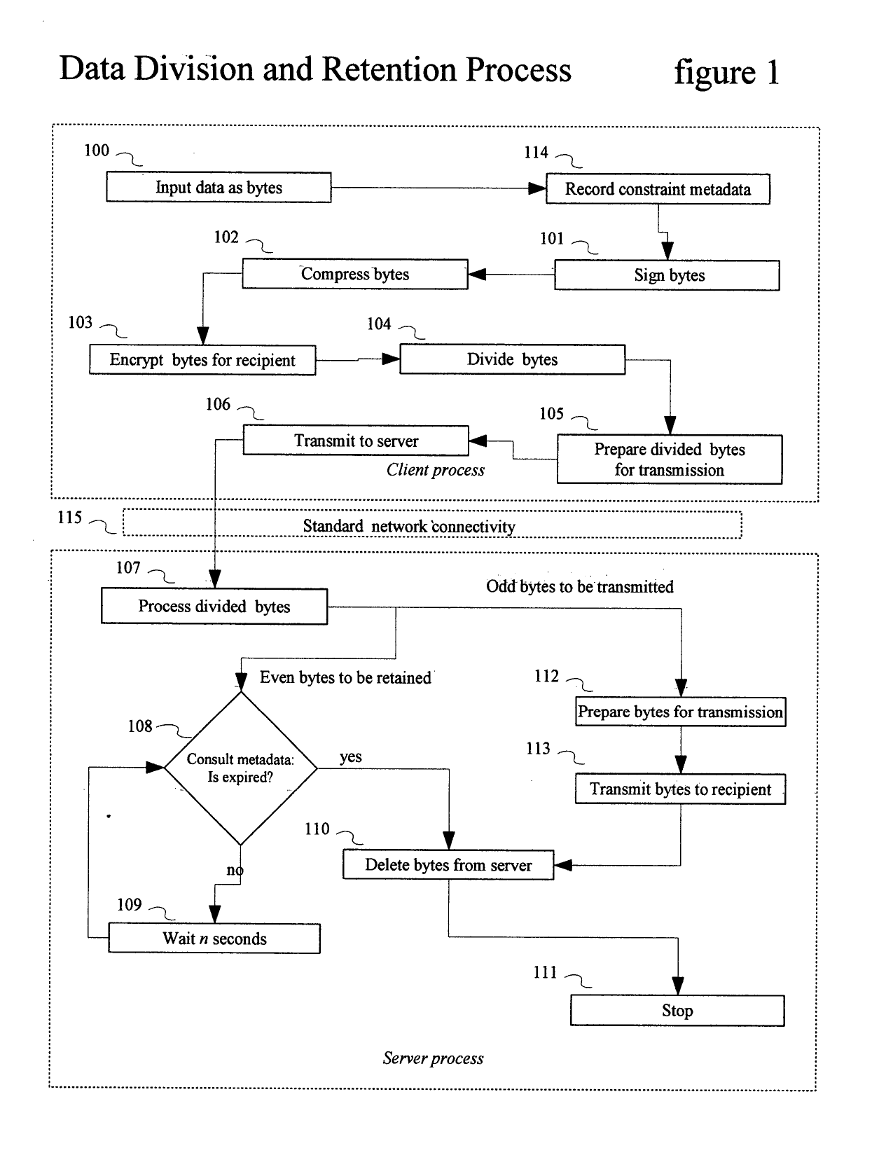

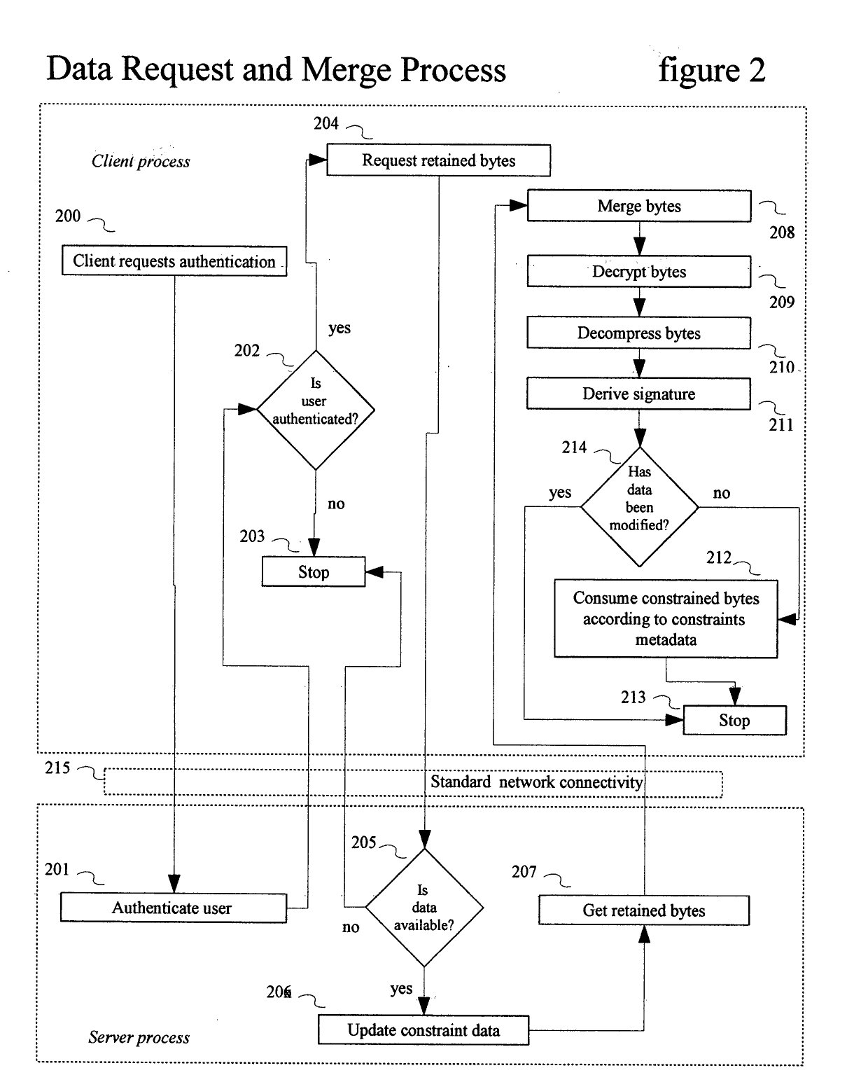

### DETAILED DESCRIPTION—FIGS. 1 AND 2—PREFERRED EMBODIMENT

A preferred embodiment of the client and server processes of the present invention is illustrated in FIG. 1 (Data Division and Retention Process) and FIG. 2 (Data Request and Merge Process).

FIG. 1 is a flowchart depicting two process: client and server processes for dividing and retaining the data to be constrained. The client application inputs data bytes into the Transience and Constraint Enforcer system 100, reads issuer's constraint meta data, digitally signs it 101, compresses it 102, and encrypts it for recipient 103. The bytes are split 104, prepared for transmission 105, and is transmitted to the server 106 using standard network connectivity 115. The server process takes over, process bytes 107, those that are retained are checked for expiration 108, a wait state is encountered at 109, a deletion routine at 110, and a process stop at 111. The bytes to be sent are prepared for transmission 112, sent to recipient 113, and deleted from the server 110.

FIG. 2 is a flowchart depicting the interaction of two process necessary to request and merge constrained data. The client requests authentication of the recipient 200 using standard network connectivity 215, from the server 201, processing stops 203 if the user is not authenticated 202. The client requests the retained bytes from the server 204, if they not available 205, then processing stops 203. Constraint information is updated 206, retained data is fetched 207, all bytes are merged 208, decrypted 209 and decompressed 210. The data's digital signature is derived 211, verified 214, and consumed according to data constraints 212, and processing stops 213.

Operation—FIGS. 1 and 2

The following descriptions shows how the Data Transience and Propagation Constraint Enforcer provides for control of transience and propagation:

1) Data Division and Retention Process: On the client that creates or manages data, bytes are input into the process 100, where they is digitally signed 101 (using the sender's private key), compressed 102, and encrypted 103 (using the recipients' public key). At this point it is divided into two separate collections 104, one consisting of all the odd source bytes, and the other comprised of all the even source bytes. The results are packaged 105 for transmission to the server 106 using standard network connectivity 115.

On the server bytes are received and processed 107, the odd bytes are prepared for transmission 112, transmitted 113 to their recipient, and deleted from the server 110. The bytes to be retained are then subject to a periodic 109 expiration check 108. Those that are expired are deleted from the server 110.

2) Data Request and Merge Process: In order to consume the transmitted data, the client software must first request authentication 200 for the data's recipient 201 using standard network connectivity 215. If the recipient cannot be authenticated 202, then processing stops 203. Otherwise, the client software requests the retained data that corresponds to the recipient's received data 204. If the requested data has is unavailable 205, then processing stops 203. Otherwise, the requested data's constraint data is updated 206 (i.e., “viewed for the nth time”, “first requested on mm/dd/yyyy”, etc.), and is fetched 207 from the data store and returned to the requester. The retained bytes are then merged 208 with the originally transmitted bytes, decrypted 209 (using the recipient's private key) and decompressed 210 on the requesting client. At this point, a digital signature is generated 211, and compared with the original signature 214 (using the sender's public key). If the signatures are equal, then the data is consumed 212 according to the constraints specified by the sender of the data. If the signatures are not equal (indicating tampering), then processing stops 213.

Advantages

From the description above, a number of advantages of the Data Transience and Propagation Constraint Enforcer become evident:
(a) The sender, or issuer of constrained data can extend their previously defined limits if the data that they have transmitted has not yet expired. Due to the logistics involved in managing client based licensing stores, this is impractical to the point of not being feasible.
(b) As of yet unwritten software clients that use the Data Transience and Propagation Constraint Enforcer to request constrained data need not know anything about the inner workings of the enforcer, only that they can, or cannot access the data. This significantly lowers the risk of constraint tampering and greatly simplifies creation and dissemination of new software products using this system.
(c) The sender, or issuer of constrained data can rescind previously allowed access to constrained data if they so wish. Due to the logistics involved in managing client based licensing stores, this is impractical to the point of not being feasible.
(d) Because one embodiment uses Public Key encryption, the data to be transmitted is only accessible by entities with access to the recipient's private key.
(e) By using data division and retention, the recipient may only access the data they have received as long as the complementary retained data still exists on the separate designated server computer.
(f) Because the creation of digital signatures occurs before transmission, any of the sender's transmitted meta data governing transience that is tampered with is detected via comparison of the digital signatures of both the original and newly recomposed data. Any data sets that are modified in transit are considered to be forgeries by the Data Transience and Propagation Constraint Enforcer, and are thus discarded before consumption or rendering can take place.
   Conclusions, Ramifications, and Scope

Accordingly, the reader will see that the Data Transience and Propagation Constraint Enforcer can be used to significantly mitigate the risk of data redistribution and access beyond the constraints envisioned and imposed by the issuer of the data. In addition, this approach also increases the recipient's confidence that the data that they are consuming is authentic and has not been tampered with. Additional advantages of include, but do not limit, the use of this invention in the following scenarios:
Economic transactions, in which a purchaser's credit card information is generally stored indefinitely, could be conducted with significantly reduced risk of inadvertent exposure or theft. If the purchaser places a two day constraint on the viewability of their encrypted credit card information, then it is far less likely that their valuable credit card data will be stolen or exposed weeks or years after their transactions have taken place.
People who hold controversial opinions might be encouraged to speak up without fear of retribution; a failing project might be labeled as such in an internal memo that is not meant to be recirculated; a political dissident or a whistle blower may speak their minds knowing that their words are less likely to “come back to haunt them”.
Issuers of valuable data, such as surveys and demographic data, can ensure that their subscribers only have the level of access to the information that they are currently paying for. In an information economy, the savings of otherwise lost revenue could be significant.

Although the description above contains many specificities, these should not be construed as limiting the scope of the invention but as merely providing illustrations of some of the present preferred embodiments of this invention. For example, the programming languages used to implement this system are interchangeable, as is the encoding scheme for transmission, and the type of data to be constrained; The type of network connectivity is immaterial to this method, as long as data is exchanged between the client and server software with a desirable level of celerity and fidelity; The percentage of data retained and transmitted can vary arbitrarily, along with the use of multiple data division and retention repetitions for storage on multiple “data escrow” server computers; Additionally, the division of constrained even and odd byte sets could easily replaced by another predetermined division algorithm; Further, although Public Key cryptography is assumed, this is not a requirement for establishing data integrity; nor is the encryption algorithm used for bulk encryption required to constant, it may also be considered to be as interchangeable as any of the other previously mentioned alternatives used to implement the embodiment described above.

Thus, the scope of the invention should be determined by the appended claims and their legal equivalents, rather than by the examples given.

What is claimed:

1. A method for constraining and disabling the redistribution of computer data that are not intended to be disseminated further than their intended recipients; for constraining and enforcing the transience of electronic data beyond a given expiration date; for constraining and enforcing the transience of electronic data beyond a given maximum number of times accessed; for constraining and enforcing a data issuer's permissions to forward, print, copy or archive the issued electronic data, comprising the following two processes:
(a) a data division and retention process comprising: a client computer with memory in which an issuer and their data to be constrained is associated with a set of constraint meta data chosen by the issuer pertaining to an issued data set's transience, propagatability, copiability, archivability and printability; digitally signing the constrained data and the meta data using a cryptographic signing algorithm, encrypting the constrained data and meta data using an encryption algorithm, dividing the digitally signed data and meta data into even and odd byte sets; transmitting the divided data and meta data to a server computer for further processing, transmitting from the server the odd bytes of the divided data and meta data to a recipient chosen by the issuer, deleting from the server the odd bytes of the divided data transmitted to the recipient, storing the remaining even bytes on the server; periodically ascertaining and deleting the even bytes when they have expired according to the constraint meta data associated with it by the issuer,
(b) a data request and merge process comprising: authenticating the recipient, ceasing processing if the recipient is not authenticated, ascertaining if the remaining even bytes of constrained data and meta data is still available for consumption by the recipient, returning the even bytes and meta data to the recipient if it is still available for consumption, updating the constraint meta data's last access count, time and date, merging the retained even bytes and meta data with the recipient's received odd bytes on the recipient's computer, decrypting the merged data, verifying the digitally signed merged data, terminating processing if the merged data has been modified, ascertaining which consumption operations the data issuer allows, consuming the constrained data according to the data issuer's previously recorded constraints,
whereby said data transience and propagation method will inhibit or enable the recipient's capacity to consume and manipulate the constrained data,
whereby a sender may constrain how the data that they issue may be consumed and manipulated by an intended recipient.

2. A method for constraining and disabling the redistribution of computer data that are not intended to be disseminated further than their intended recipients; for constraining and enforcing the transience of electronic data beyond a given expiration date; for constraining and enforcing the transience of electronic data beyond a given maximum number of times accessed; for constraining and enforcing a data issuer's permissions to forward, print, copy or archive the issued electronic data, comprising the following two processes:
(a) a data division and retention process comprising: a client computer with memory in which an issuer and their data to be constrained is associated with a set of constraint meta data chosen by the issuer pertaining to an issued data set's transience, propagatability, copiability, archivability and printability; digitally signing the constrained data and the meta data using a cryptographic signing algorithm, encrypting the constrained data and meta data using an encryption algorithm, dividing the digitally signed data and meta data into a plurality of predetermined subsets; transmitting the divided data and meta data to a server computer for further processing, transmitting from the server a predetermined plurality of the divided data subsets and meta data to a recipient chosen by the issuer, deleting from the server the subsets of data transmitted to the recipient, storing a predetermined plurality of the remaining subsets of bytes on the server; periodically ascertaining and deleting the plurality of the remaining subsets of bytes when they have expired according to the constraint meta data associated with it by the issuer,
(b) a data request and merge process comprising: authenticating the recipient, ceasing processing if the recipient is not authenticated, ascertaining if the remaining predetermined plurality of remaining subsets of bytes of constrained data and meta data is still available for consumption by the recipient, returning this plurality of predetermined remaining subsets and meta data to the recipient if it is still available for consumption, updating the constraint meta data's last access count, time and date, merging all of the retained byte subsets with the recipient's received byte subsets on the recipient's computer, decrypting the merged data, verifying the digitally signed merged data, terminating processing if the merged data has been modified, ascertaining which consumption operations the data issuer allows, consuming the constrained data according to the data issuer's previously recorded constraints,
whereby said data transience and propagation method will inhibit or enable the recipient's capacity to consume and manipulate the constrained data,
whereby a sender may constrain how the data that they issue may be consumed and manipulated by an intended recipient.
